(19) United States
(12) Patent Application Publication
(10) Pub. No.: US 2007/0175643 A1
(43) Pub. Date: Aug. 2, 2007

(54) Three-in-one equine hoof tool

(75) Inventor: Janet Byrum Erwin, Clemmons, NC (US)

Correspondence Address: Janet Byrum Erwin, 115 Lower Brook Ct., Clemmons, NC, 27012, US

(73) Assignee: Janet Byrum Erwin, Clemmons, NC (US)

(21) Appl. No.: 11/557,063

(22) Filed: Nov. 6, 2006

Related U.S. Application Data
(60) Provisional application No. 60/733,873, filed on Nov. 7, 2005.

(51) Int. Cl. A01L 11/00

(52) U.S. Cl. 168/48.1

(57) ABSTRACT

The three-in-one equine hoof tool is a unique all-inclusive hoof grooming tool combining a hoof pick, hoof brush, tough-debris scraper and an ergonomic handle all within a whimsical equine-shaped body. The tool is the first of its kind to offer an arch-shaped hoof brush, which allows semi-circular brushing action along the sides of the frog for the comfort of the equine during enhanced debris removal.

### CROSS REFERENCE TO RELATED APPLICATION

Not applicable.

### STATEMENT REGARDING FEDERALLY SPONSORED RESEARCH OR DEVELOPMENT

Not applicable.

### BACKGROUND OF THE INVENTION

Although pet and equine grooming tools with combined functionality are not new, the subject of this utility patent application, the three-in-one equine hoof tool, is unique in its combined functionality as described in the Brief Summary of the Invention below. Currently, the equine grooming tool market contains variations of hoof picks with horse-head handles, hoof picks with brushes at the end, hoof picks with horse-head handles and brushes at the end, hoof picks with ergonomic handles, etc. The individuality of this equine hoof tool is evident in its combination of materials, 3-way grooming capacity, and elevation of style to enhance ergonomic functionality.

### BRIEF SUMMARY OF THE INVENTION

The three-in-one equine hoof tool that is the subject of utility patent review under this application is the first comprehensive equine grooming tool developed that achieves that following:
Combines the functionality of not only a hoof pick and a brush, but also a tough-debris scraper to remove extra stubborn particles gently, even near the coronet band where scraping with sharp metal objects would cause discomfort to the animal.
Incorporates novel arch-shaped brush that allows semi-circular sweeping action for better removal of debris from against the frog, as opposed to poking at debris as with existing paint-brush style hoof brushes with straight-aligned bristles.
Equine-shaped body, while eye-catching and whimsical, enhances functionality by providing a handle that fits the contours of the palm, which maximizes grip, user comfort, and—because of these—overall tool effectiveness.

### BRIEF DESCRIPTION OF THE SEVERAL VIEW OF THE DRAWING

The patent or application file contains at least one drawing executed in color. Copies of this patent or patent application publication with color drawing(s) will be provided by the Office upon request and payment of the necessary fee.

Color drawings have been utilized in this patent application to create the best possible depiction of uniqueness of the equine hoof tool, which is largely attributable to the combined functionality of the components and their relationships to each other, where choice of materials influence overall functionality and practicality. Traditional black and white lineart methods fail to communicate as effectively.

Page 1 of the Drawings presents FIG. 1 Frontal View.

Page 2 of the Drawings presents FIG. 2 Side View.

FIG. 1 Frontal View shows the components of the equine hoof tool, their placement and function.

FIG. 2 Side View shows the proposed elevation of the contoured handle.

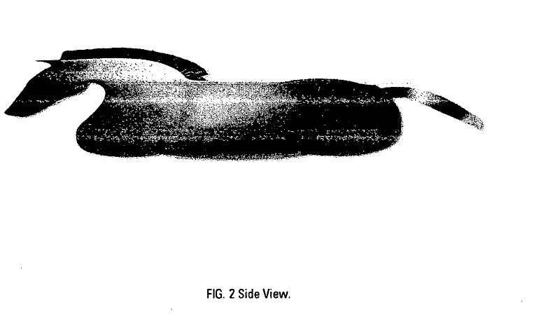

Design renderings are preliminary. Modifications may be necessary during final product development.

### DETAILED DESCRIPTION OF THE INVENTION

Materials

Using materials standard in the production of existing equine grooming tools, the three-in-one equine hoof tool evolves beyond traditional devices in the way the materials are implemented. The following materials are suggested for the three-in-one equine hoof tool's components, although it is well known that alternate materials present possibilities. The inventor wishes to procure patent protection before soliciting manufacturing specifics.
Pick (tail): stainless-steel to resist rust and bending, or high-strength aluminum.
Handle (equine-shaped body): rubber-coated high-density plastic; rubber coating tapering off to exclude the tough-debris scraper (ear).
Tough-debris scraper (ear): extends seamlessly from the body of the tool, which is suggested to be high-density plastic.
Brush (mane): nylon or other synthetic bristles, however, the potential for natural bristles exits.
   Manufacturing

While processes such as injection molding are reasonable to pursue, alternate production avenues present possibilities. The inventor wishes to procure patent protection before soliciting manufacturing specifics.

Distinguishing Characteristics

While the most distinguishing characteristic is most likely whimsy, the side-effect of its whimsical design is an evolution in combined fuctionality within the equine grooming industry. In particular, the “neck” of the equine-shaped tool giving placement to an arch of bristles well suited for semi-circular brushing movement against the frog of the sole for efficiently removing debris, rather than poking at the debris with a straight brush. What's more is the addition of the tough-debris scraper conveniently built into the tool for removing stubborn particles that typically accumulate on the outside of the hoof that brushes often leaves behind. With the three-in-one equine hoof tool, a user can not only pick the hoof, but remove particles from the sole, along the frog and from the outside of the hoof—all while holding an easy-to-grip handle.

1. The three-in-one equine hoof tool is the first equine grooming tool to combine the functionality of the following components in an all-inclusive unit: hoof pick, hoof brush, tough-debris scraper and ergonomic handle.

2. The three-in-one equine hoof tool is the first equine grooming tool to offer an arch-shaped brush.

3. The arch-shaped brush allows semi-circular brushing action against the frog of the sole. This action is preferable to poking at the debris as with a straight brush typical of existing hoof grooming tools.
